(19) United States
(12) Patent Application Publication
(10) Pub. No.: US 2022/0077522 A1
(43) Pub. Date: Mar. 10, 2022

(54) Electric battery module and battery comprising at least one such module

(71) Applicant: SOGEFI AIR & COOLING, GUYANCOURT (FR)

(72) Inventors: Nicolas BECKER, PORTE DU RIED (FR); Alexandre FLORANC, LOGELSHEIM (FR); Jonathan HALBARDIER, TUCKHEIM (FR)

(21) Appl. No.: 17/418,647

(22) PCT Filed: Dec. 23, 2019
(86) PCT No.: PCT/EP2019/086902

§ 371 Date: Jun. 25, 2021

(30) Foreign Application Priority Data
Dec. 28, 2018 (FR) 1874291

(51) Int. Cl. H01M 10/6568; H01M 50/213; H01M 10/653; H01M 10/625; H01M 10/643

(52) U.S. Cl. CPC H01M 10/6568; H01M 50/213; H01M 2220/20; H01M 10/625; H01M 10/643; H01M 10/653

(57) ABSTRACT

The invention relates to an electric battery module (1) comprising a plurality of individual accumulators (2) in the form of cylindrical elements arranged in parallel rows mounted in a container (3).

Said battery module (1) is characterized in that the container (3) comprises:

for the one part, at least one support body (4) made of a rigid material that is a good heat conductor in the form of a profiled component having a comb-shaped cross section, forming elongate housings that are each configured to receive, in a non-fitted manner, a row of battery elements (2), and,
for the other part, at least first mechanical wedging means (8) that prevent the movements of said elements (2) at least in the longitudinal direction of the housing that receives them and space apart said elements (2) from the two compartmentalizing walls (5) that define said housing.

The present invention relates to the field of the storage of electrical energy, more particularly that of electric batteries comprising a plurality of individual accumulators, in particular batteries for motor vehicles, and the subjects thereof are a battery module and a battery comprising at least one such module.

Many batteries, in particular with great autonomy and high power, in particular batteries on board combustion engine vehicles, hybrid vehicles and electric vehicles, are currently made up of a large number of individual battery elements (elementary accumulators), in particular of the Li-ion or Li-polymer type.

Each of these elements is, as standard, in the form of a sealed and electrically insulated cylinder provided with connection terminals at its opposite ends or at one end. In order to be kept grouped together in the assembled state, they are connected together, generally by adhesive bonding or resin bonding, in blocks or packs, on one or more stage(s).

However, such an assembly held together with a binder material exhibits drawbacks.

Thus, when the number thereof is high, overheating (on account of a short-circuit or a malfunction) of an element may damage the entire battery by contamination and amplification caused by the confinement. Moreover, temperature control of the internal elements of such a pack by natural ventilation is problematic, if not impossible. Moreover, in the event of one element of a pack failing, the entire pack has to be changed. Lastly, the integrity over time of the material assembly under demanding climatic conditions is questionable and the consistency of the quality of production of the assembly is dubious.

In order to try to overcome these drawbacks, means for mechanically joining the elements together, in a protective casing, have been proposed.

However, generally, these known solutions employ a large number of separate holding parts, in particular when the battery elements need to be held individually, requiring an outer shell that is strong and able to take up the internal stresses, and/or are not designed for the purpose of effective thermal control of all of the elements, or for protecting the majority of the elements if just one of them fails.

Therefore, the problem addressed by the invention consists in providing a simple battery embodiment that provides improved thermal control compared with the known solutions, without making the design more complex and without requiring forced ventilation, and in which the elements are held securely and advantageously so as to be protected if one of them fails.

Lastly, the proposed embodiment should be able to be easily adaptable to battery formats of variable size and power.

To this end, a subject of the invention is an electric battery module, in particular a motor vehicle battery module, comprising a plurality of individual accumulators in the form of battery elements or cells of elongate, and preferably cylindrical, shape, these battery elements, which exhibit higher thermal conductivity in their longitudinal direction than in their radial direction, being arranged in parallel rows, connected electrically together and to the terminals of the module and mounted in a container that forms part of said module,

said battery module being characterized in that the container comprises:
for the one part, at least one support body made of a rigid material that is a good heat conductor, in particular a metal material such as aluminum or an alloy thereof, this support body being in the form of a profiled component having a comb-shaped cross section, with a plurality of compartmentalizing walls that are mutually parallel and regularly spaced apart from one another and with a bottom wall connecting said compartmentalizing walls to their bases, each pair of adjacent compartmentalizing walls delimiting, with the bottom wall, a profiled groove forming an elongate housing configured to receive, in a non-fitted manner, a row of battery elements with their longitudinal axes perpendicular to the bottom wall and bearing on the latter, and,
for the other part, at least first mechanical wedging means, which are attached or integrated and extend at least partially between two adjacent battery elements, for all the elements in one and the same row, so as to limit, preferably prevent, the movements of said elements at least in the longitudinal direction of the housing that receives them and to space apart said elements from the two compartmentalizing walls that define the elongate housing that receives them.

The invention will be understood better by virtue of the following description, which relates to preferred embodiments that are given by way of nonlimiting examples and are explained by reference to the appended schematic drawings, in which:

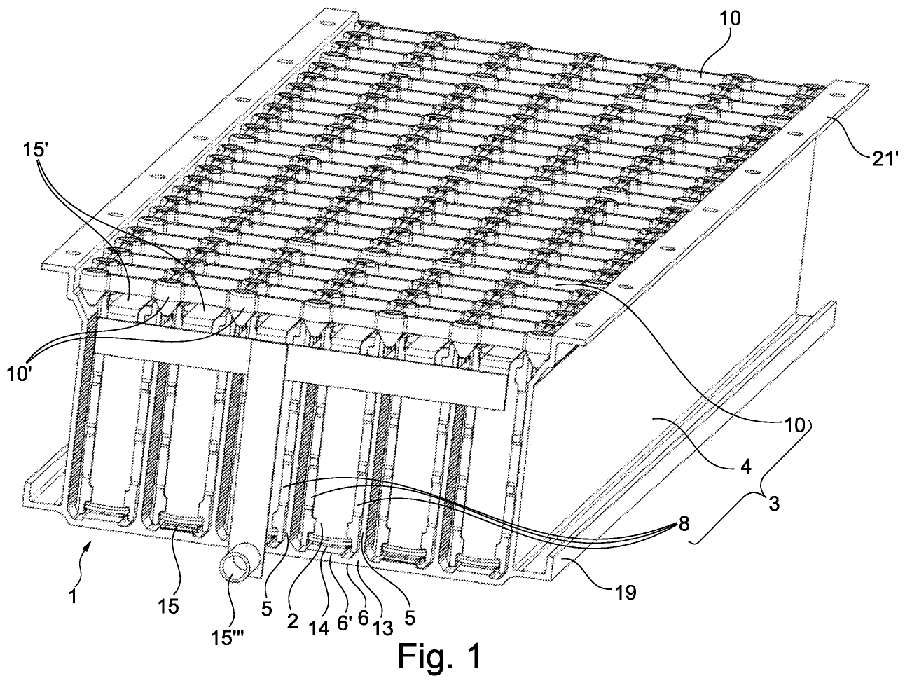

FIG. 1 is a perspective view of a battery module according to the invention;

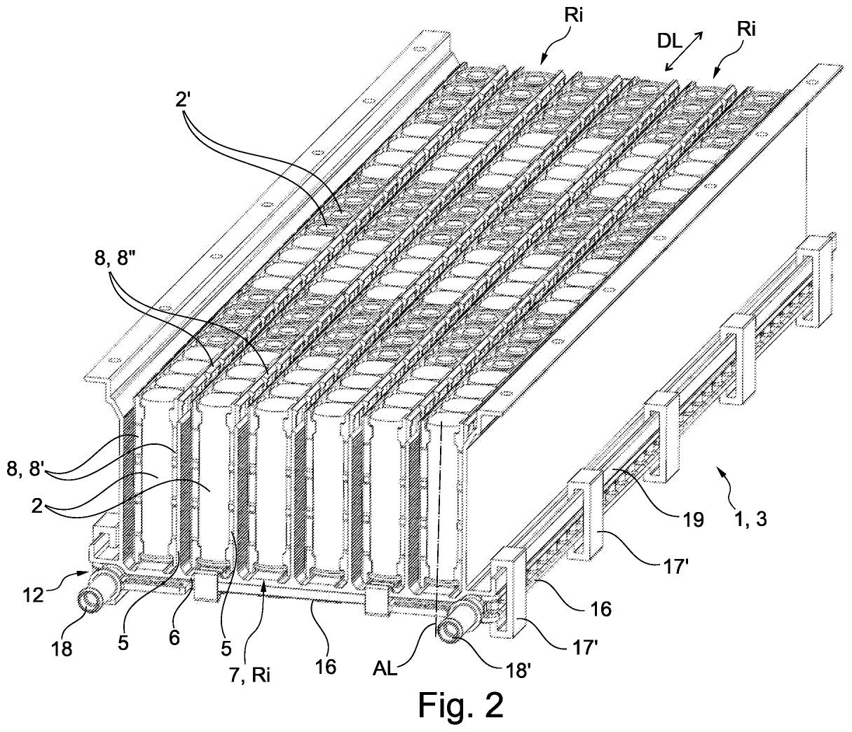

FIG. 2 is a perspective view of the module in FIG. 1, the second wedging element or means having been removed and a specific thermal control means having been attached;

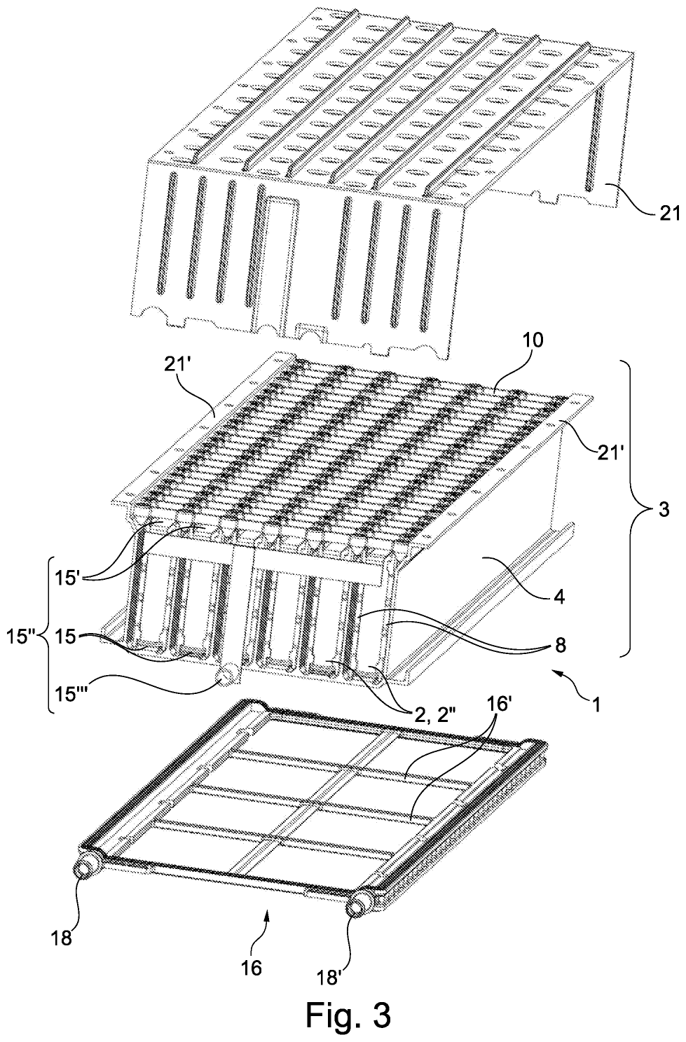

FIG. 3 is a partially exploded view of a battery according to a first embodiment of the invention, incorporating a single battery module as shown in FIG. 1;

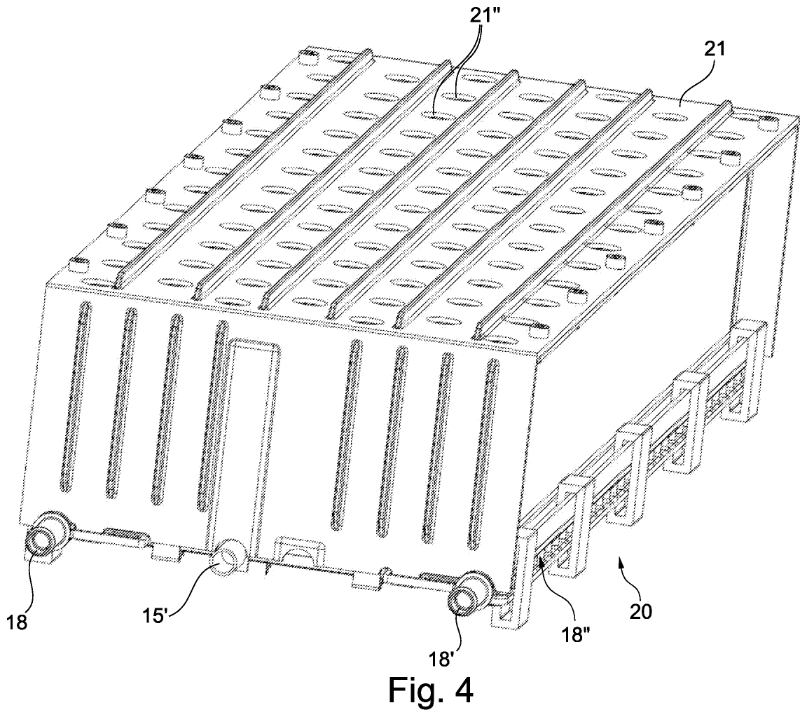

FIG. 4 is a perspective view of the battery in FIG. 3 in the joined-together state;

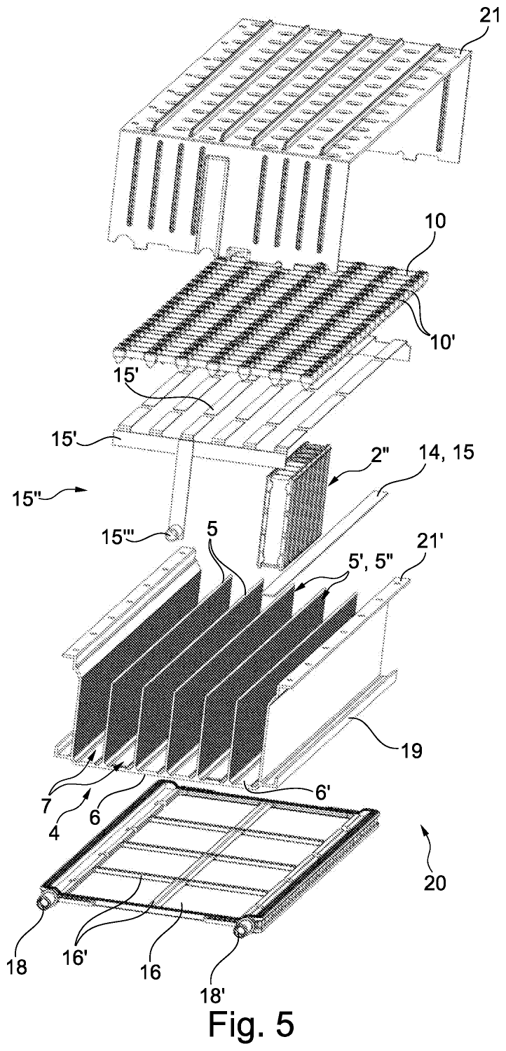

FIG. 5 is an exploded perspective view of the various constituent elements of a battery according to the invention as shown in FIGS. 3 and 4 and in accordance with the first embodiment (for reasons of clarity, only one block of battery elements is shown);

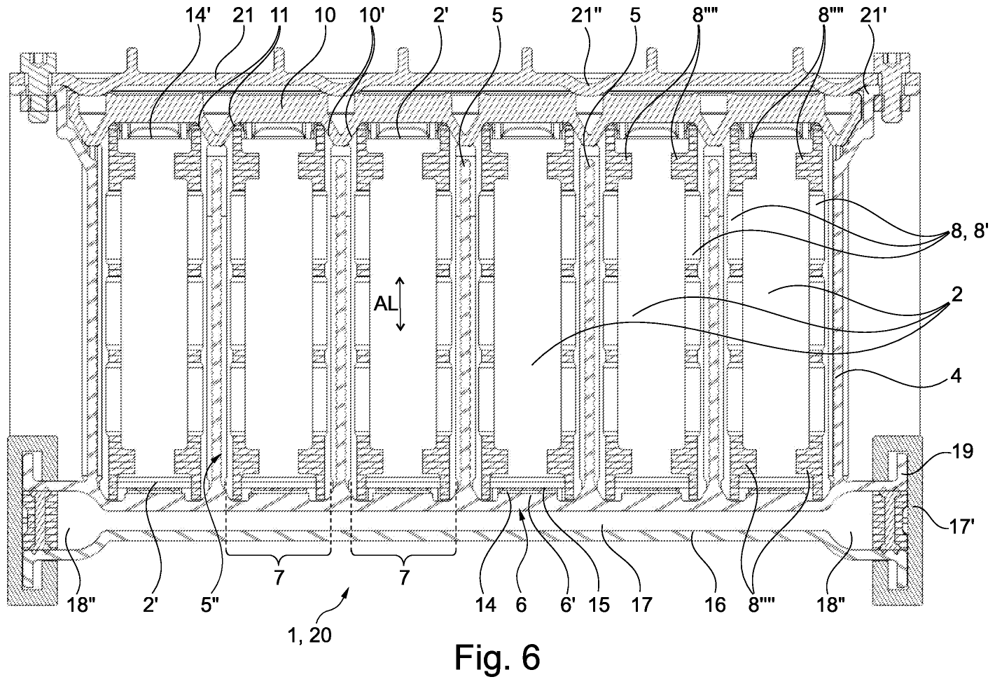

FIG. 6 is a truncated cross-sectional view, on a plane perpendicular to the longitudinal direction of the receiving housings for the battery elements, of the battery shown in FIG. 4;

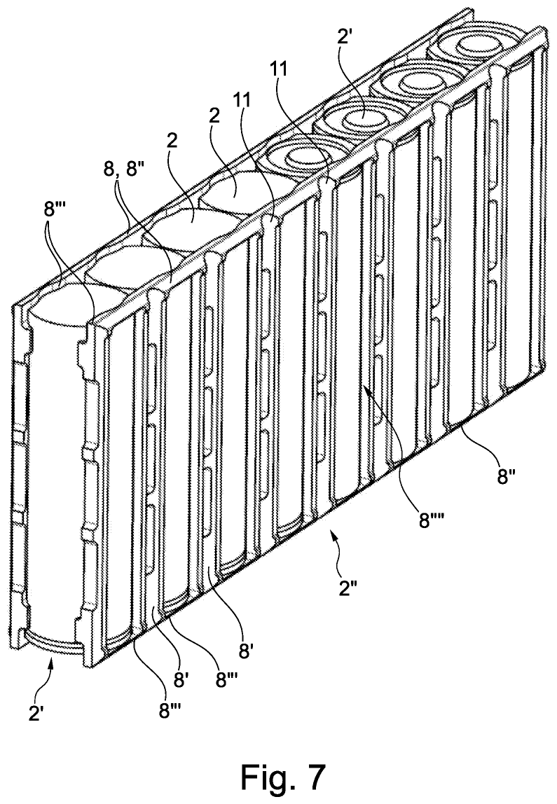

FIG. 7 is a perspective view of a block of battery elements according to the invention, which can also be seen in FIG. 5;

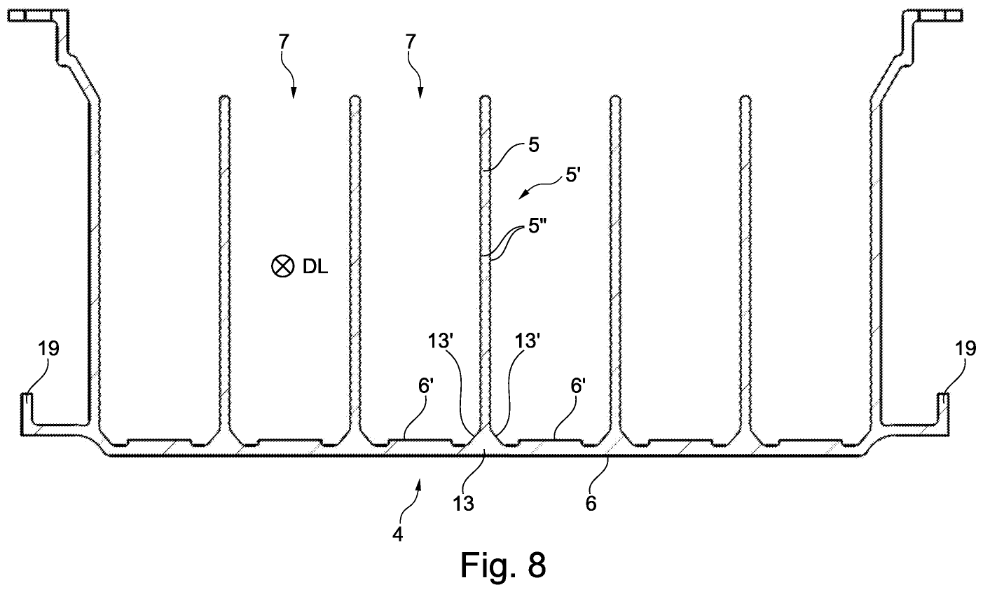

FIG. 8 is a sectional view of a support body forming part of the container of a battery module according to the invention;

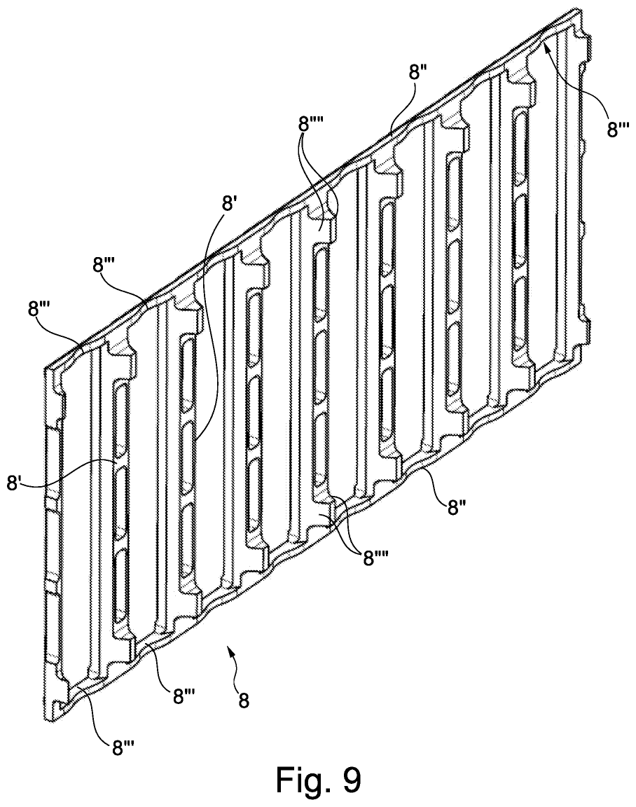

FIG. 9 is a perspective view of a first element of the wedging means forming part of a module according to the invention;

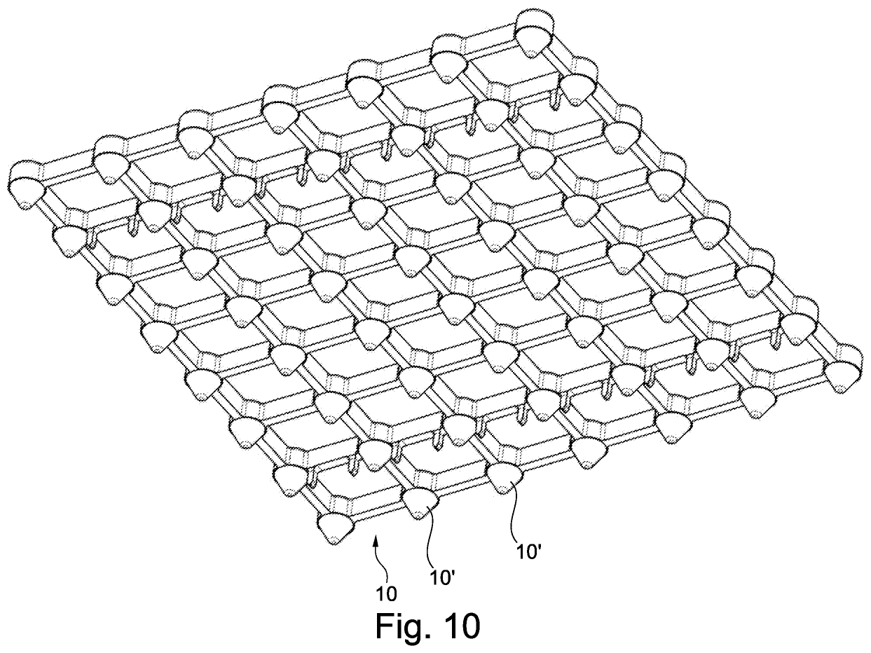

FIG. 10 is a perspective view of a second wedging element or means forming part of a module according to the invention;

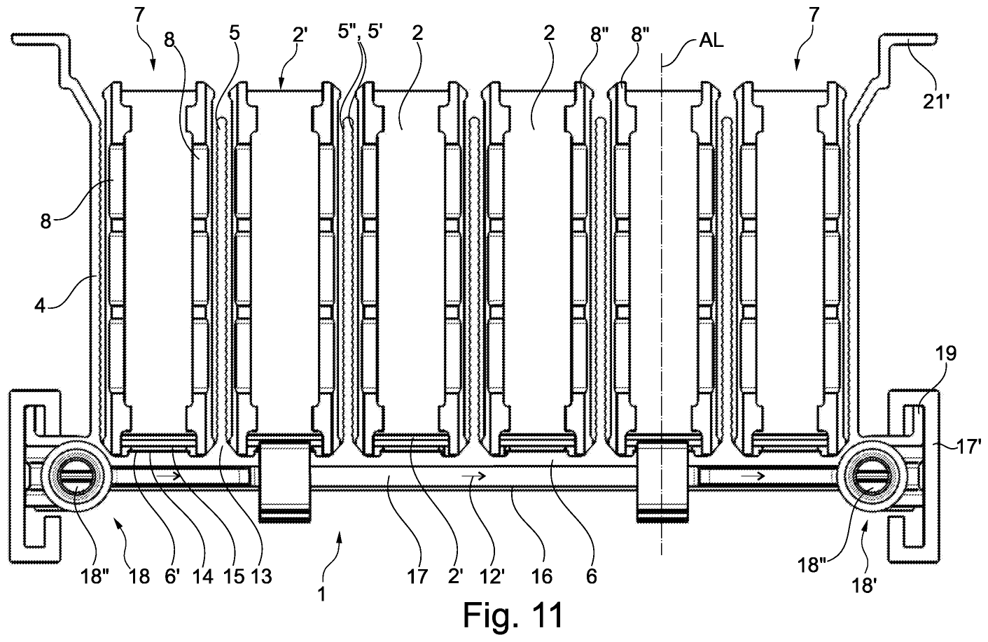

FIG. 11 is a sectional view similar to the one in FIG. 6 of the partially mounted module in FIG. 2, but equipped with a temperature control means;

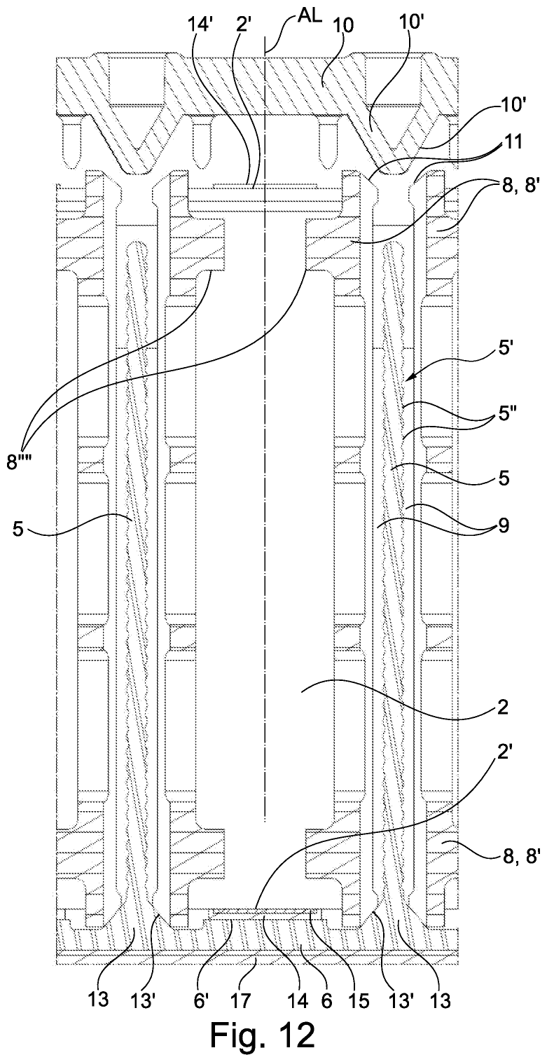

FIG. 12 is a partial detail view, on a different scale, taken from the sectional view in FIG. 11, during the fitting of the second wedging means or element;

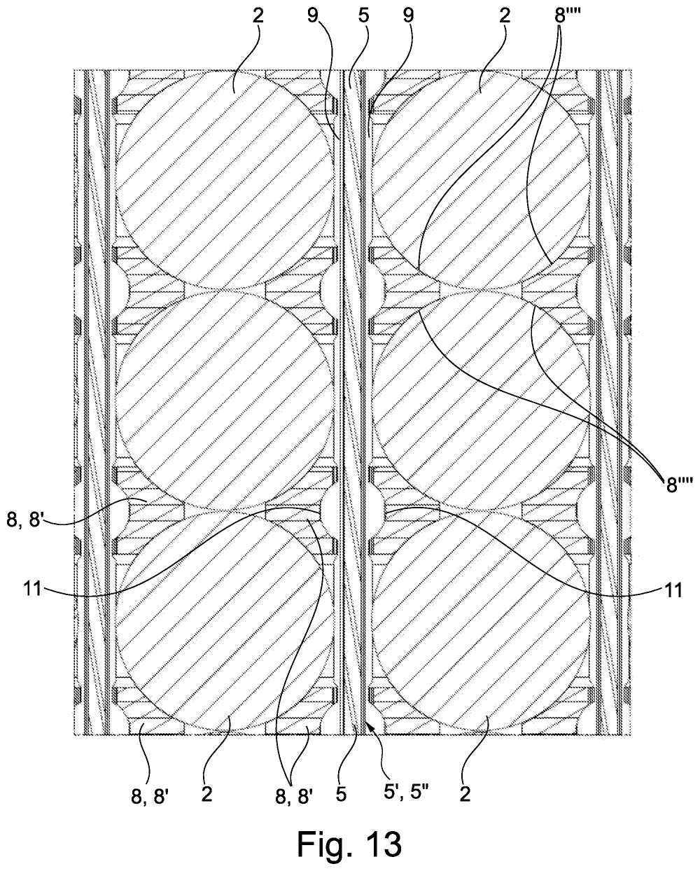

FIG. 13 is a partial top view, on a different scale, of the partially assembled battery module in FIG. 11;

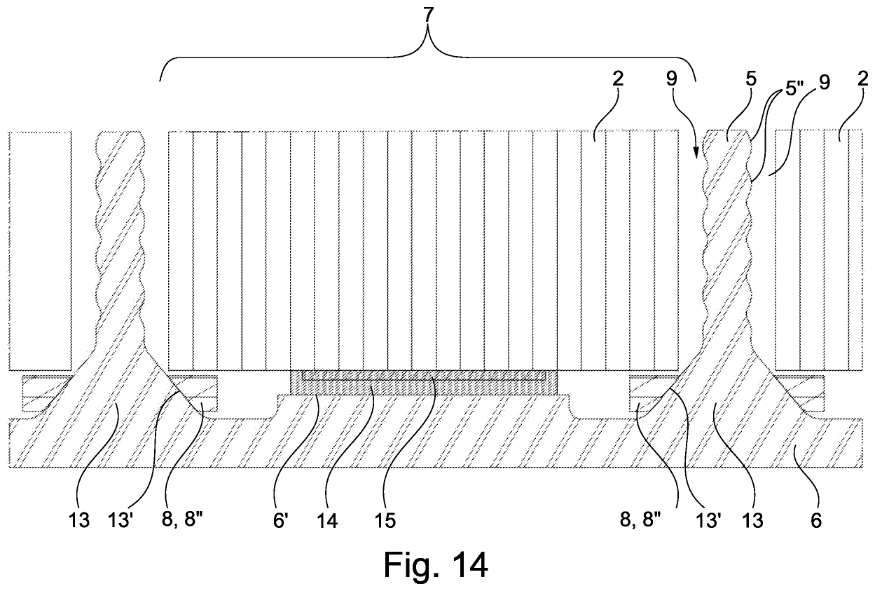

FIG. 14 is a detail view, on a different scale, of the bottom wall and of the lower end of a battery module as shown in FIGS. 1 and 6;

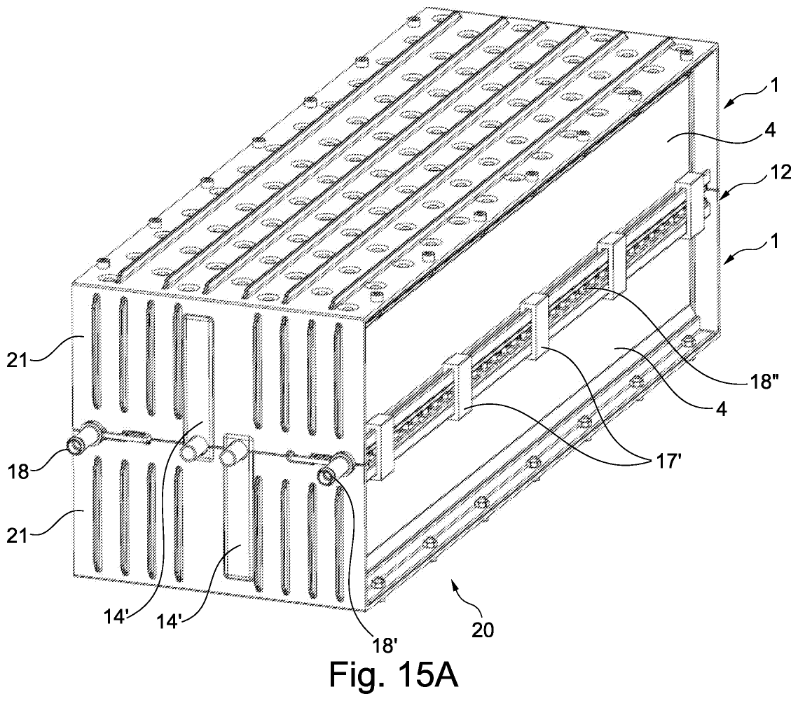

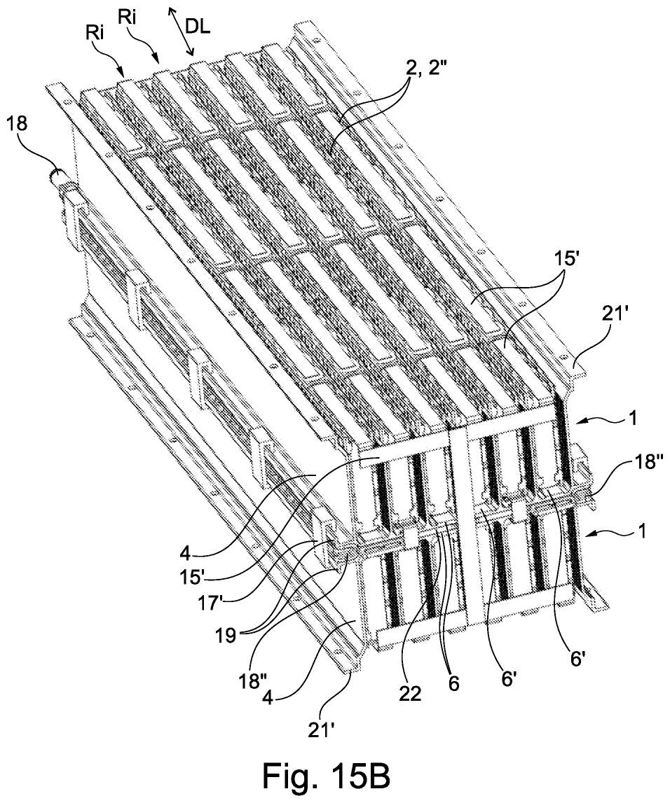

FIG. 15A is a perspective view of a second embodiment of a battery incorporating two battery modules according to the invention;

FIG. 15B is a perspective view of the battery shown in FIG. 15A, seen at a different angle and with the covers having been removed;

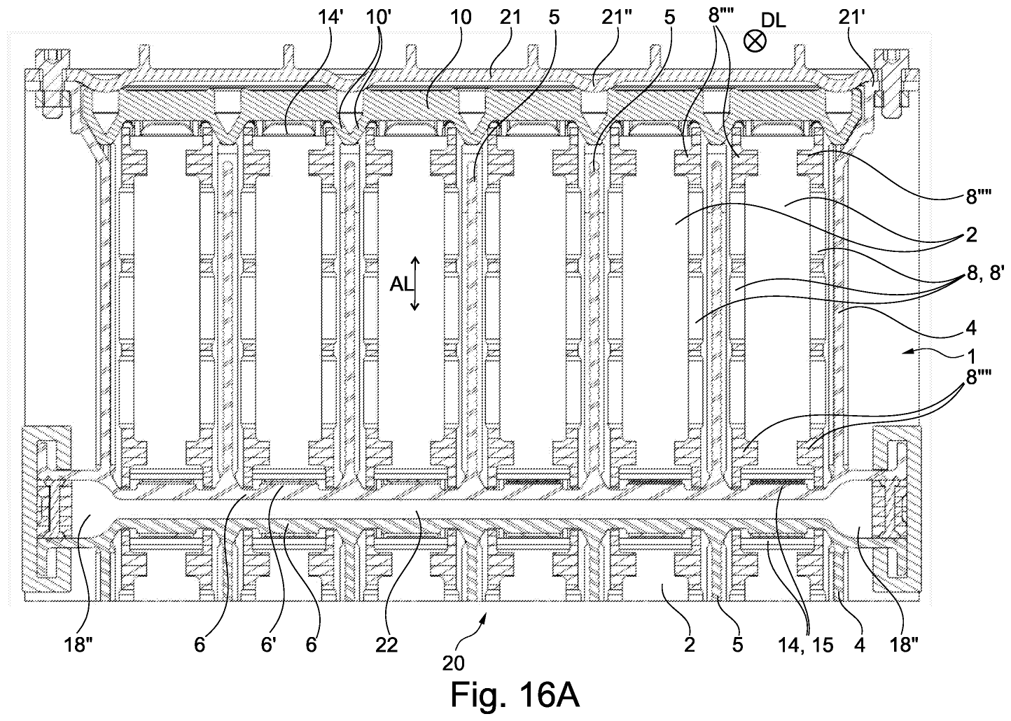

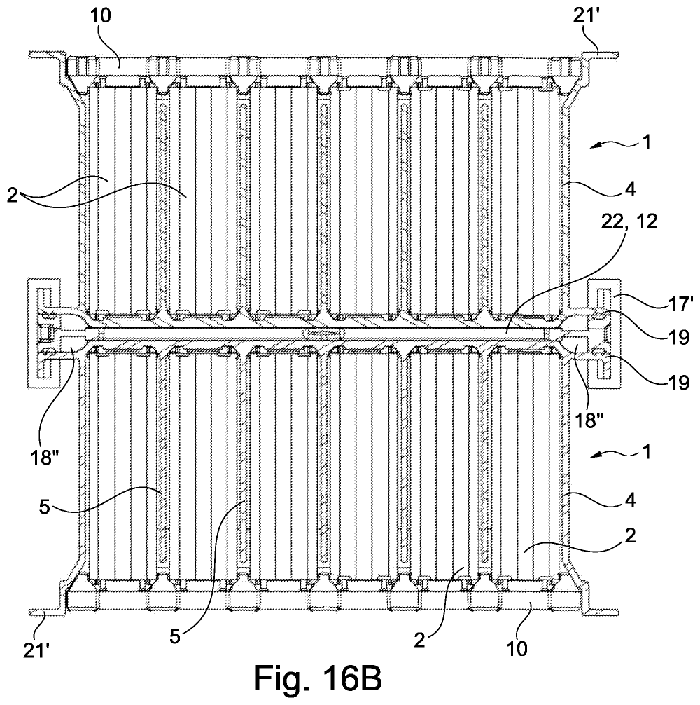

FIG. 16A is a partial sectional view, on a plane perpendicular to the longitudinal direction of the elongate housings receiving the battery elements, of the battery shown in FIG. 15A,

FIG. 16B is a sectional view of the two battery modules of a battery according to FIG. 15A, on a section plane similar to the one in FIG. 16A, according to another embodiment;

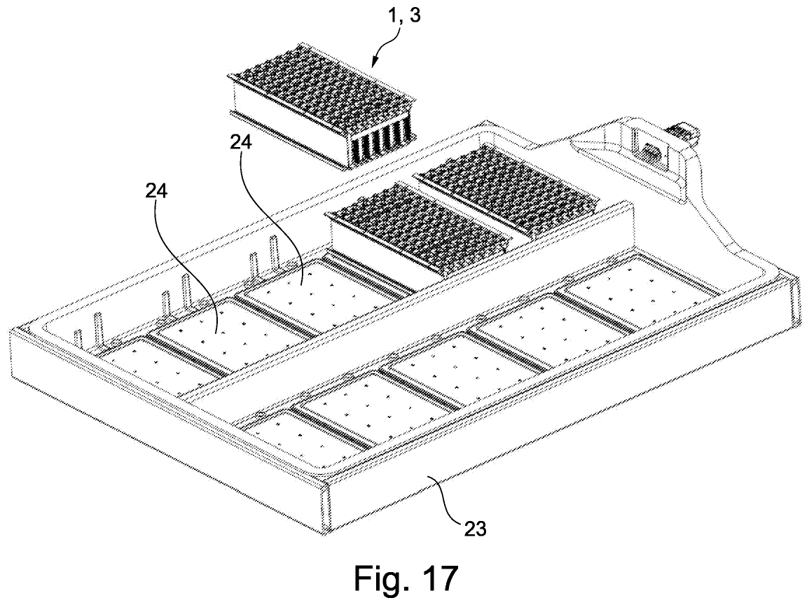

FIG. 17 is a perspective view of a third embodiment of a battery incorporating a plurality of battery modules according to the invention, this battery being in the course of being assembled; and

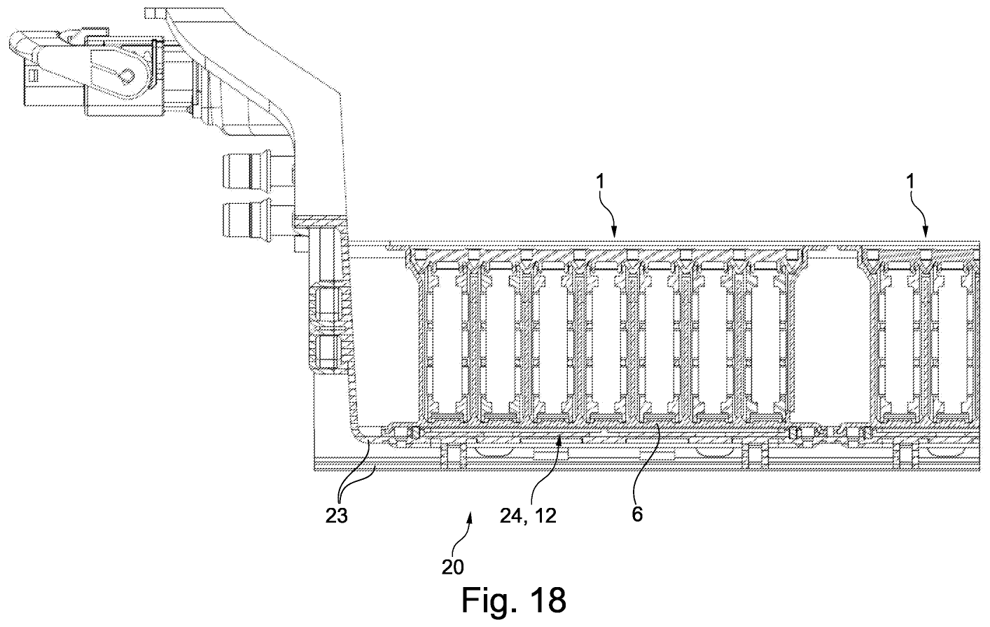

FIG. 18 is a partial cross-sectional view of the battery in FIG. 17.

FIGS. 1 to 3, 5, 11, 12, 14 and 16 all show, in some cases only in part, an electric battery module 1, in particular a motor vehicle battery module, comprising a plurality of individual accumulators 2 in the form of battery elements or cells of elongate, and preferably cylindrical, shape, these battery elements 2, which exhibit higher thermal conductivity in their longitudinal direction than in their radial direction, being arranged in parallel rows Ri, connected electrically together and to the terminals of the module 1 and mounted in a container 3 that forms part of said module 1.

In accordance with the invention, the container 3 comprises, for the one part, at least one support body 4 made of a rigid material that is a good heat conductor, in particular a metal material such as aluminum or an alloy thereof, this support body 4 being in the form of a profiled component having a comb-shaped cross section, with a plurality of compartmentalizing walls 5 that are mutually parallel and regularly spaced apart from one another and with a bottom wall 6 connecting said compartmentalizing walls 5 to their bases, each pair of adjacent compartmentalizing walls 5 delimiting, with the bottom wall 6, a profiled groove 7 forming an elongate housing configured to receive, in a non-fitted manner, a row Ri of battery elements 2 with their longitudinal axes AL perpendicular to the bottom wall 6 and bearing on the latter.

This container 3 also comprises, for the other part, at least first mechanical wedging means 8, which are attached or integrated and extend at least partially between two adjacent battery elements 2, for all the elements 2 in one and the same row Ri, so as to limit, preferably prevent, the movements of said elements 2 at least in the longitudinal direction DL of the housing 7 that receives them and to space apart said elements 2 from the two compartmentalizing walls 5 that define the elongate housing that receives them.

Thus, by providing a profiled support body 4 with a comb-shaped section, the plurality of battery elements 2, although remaining grouped together (high power density), is stored in a manner segmented into rows Ri by compartmentalizing walls 5 of the support body 4, the latter thus allowing them to be kept firmly in place, to be separated physically and electrically (mutual isolation of the rows Ri) and to be thermally controlled effectively (by exposing them individually to the temperature controlling action of the conductive lateral and bottom walls 5 and 6—this control being transposed directly to the interior of the group of battery elements 2).

The precise and individual holding of the battery elements 2 in the grooves of the support body 4 provided by the first wedging means 8 allows the formation and maintenance of air-circulation gaps 9 along the rows Ri, and around and possibly between the elements 2 of each row.

The battery elements 2 in simple alignments and having a cylindrical shape are consequently exposed over their entire lateral surface to the air flows that circulate and are controlled by the support body 4, in particular when said elements are kept at a small distance from one another by the first wedging means 8 (for example by providing projections in the form of wedges with curved contact zones 8″″ see FIGS. 7 and 9).

In addition to this locking of the battery elements 2 in position in multiple directions (two axes and one half-axis), the support body 4 also forms, with its two exterior lateral walls and its bottom wall, a protective shell.

Lastly, by providing a support body 4 in the form of a one-piece metal profile (produced for example by extrusion) and having a comb-shaped cross section (which therefore integrally incorporates lateral walls 5 and bottom wall 6), the invention provides a design that is simple, robust, optimized in terms of exchanges of heat and thermal conduction (given the shape of the walls 5 and 6) and has a base component—the support body 4—that is easy and inexpensive to produce and by itself already ensures wedging in several directions. In addition, this support body 4 ensures that the pack of battery elements 2 is subdivided into a plurality of rows of single-file elements, which are easier to cool, and therefore each element 2 is exposed at most to a circulation of air between two lateral walls in contact with a bottom wall, these different walls all being temperature controlled.

Advantageously, as is shown in FIGS. 1, 2, 6, 7 and 9, the first wedging means 8 consist either of attached spacing components that are interposed between the faces of the two opposite compartmentalizing walls 5 of each housing 7 and the battery elements 2 received in this housing 7, or of protruding, profiled or non-profiled, formations that project from the faces of said walls 5. These components or these formations 8 are configured and positioned to form gaps 9 between the battery elements 2 and said faces 5′ of the walls 5, advantageously to keep the battery elements 2 away from the faces 5′ in question in each case, preferably to lock them in position in a centered manner in the housing 7 in question.

Preferably, these first wedging means 8 consist, for each housing 7, of attached components in the form of ladders, or of frames provided with cross pieces, the crossmembers or cross pieces 8′ of which constitute or carry stopping and spacing elements (for example in the form of wedges) that are positioned respectively between two adjacent battery elements 2 and act as linear or surface contact zones 8″″ with the latter, these wedging components 8 being disposed between the faces 5′ of the compartmentalizing walls 5 and the row Ri in question of battery elements 2, on either side thereof. Each pair of opposite wedging components 8 thus forms a cage confining at least a part of the battery elements 2 of the row Ri received in the profiled housing 7 in question. The alignment of elements 2 in the row is thus segmented by these pairs of opposite components 8 into modular units, each enclosing several elements (4, 8 or 12 for example).

According to a first design variant of the invention, allowing the battery elements 2 to be structured into preassembled sub-modules, making it easier to assemble the battery module 1, the side members 8″ of the ladder- or frame-like wedging components 8 have edges 8′″ configured to come into contact, between two crossmembers or cross pieces 8′, with the upper and lower ends of the cylindrical battery elements 2, if appropriate under pressure and/or with elastic deformation, specifically at the lateral edge portions of said ends, the battery elements 2 confined between two wedging components 8 thus forming a block 2″ therewith (FIGS. 5 and 7).

In these blocks 2″, which comprise for example 4 or 8 battery elements 2 each, these elements can be oriented in an identical or non-identical manner (for example each half of the elements 2 has its own orientation, which is the reverse of that of the other).

According to a second design variant of the invention, which is not shown in the figures, the first wedging means 8 consist of protruding formations, such as bosses, ridges, spikes or the like, that are an integral part of the faces of the compartmentalizing walls 5 or of components mounted on the latter, for example by interlocking.

In order to lock the battery elements totally in the support body, i.e. in all directions, the container 3 also comprises second wedging means 10 that are configured and arranged to lock the battery elements 2 (assembled in the form of blocks 2″ for example) against the bottom wall 6. These second wedging means 10 are advantageously in the form of a panel having a meshwork structure extending above the elongate housings 7 of the support body 4 and the different rows Ri of battery elements 2 and, if appropriate, coming into mechanical engagement with the first wedging means 8, above the compartmentalizing walls 5, in order to ensure that they are fixed in position in the upper part of the housings 7 and to ensure that they cooperate intimately with said battery elements 2 (see FIGS. 1, 3, 5, 6, 10 and 16 in particular).

Advantageously, the meshwork-structure panel 10 has formations 10′ that are conical, beveled or in the form of wedges configured to be inserted between the upper side members 8″ of the ladder- or frame-like first wedging components 8 disposed on either side of a given compartmentalizing wall 5, at sites 11 with complementary shapes to said side members 8″, so as to urge each of said side members 8″ and the crossmembers 8′ (of the components 8 in question) to come into contact with the battery elements 2 in question in each case that are sandwiched between two mutually opposite first wedging components 8.

The temperature control of the support body 4 by a suitable means can be realized in different ways, for example by the Peltier effect, by exposure of a temperature-controlled forced air flow or the like.

However, according to one embodiment which is effective, economical and easily structurally integrable, provision is advantageously made for the bottom wall 6 to be subjected, preferably substantially over its entire surface, to the action of a thermal control means 12, for example of the type involving circulation of heat transfer fluid 12′, said thermal control means 12 either belonging to said module 1 in question, or being shared between at least two modules 1, or belonging to a set of thermal control means associated with a plurality of modules 1.

Such a thermal control means 12 may also be easily connected to the fluid circulation circuits of a vehicle, in the case of an onboard battery.

In order to promote and optimize the transmission of the effects of the thermal control between the walls 5 and the air circulating by natural (or forced) convection, and advantageously also upstream between the bottom wall 6 and the walls 5, the invention may provide for the compartmentalizing walls 5 to have, on their two faces 5′, a non-flat surface structure 5″, for example provided with a pattern of grooves/ribs or profiled undulations. In addition, the junction zones 13 of said compartmentalizing walls 5 with the bottom wall 6 advantageously have a section that flares in the direction of the latter, providing inclined or beveled laterally supporting and centering surfaces 13′ for the first wedging means 8 and/or the battery elements 2. The side members 8″ may have external edges beveled in a complementary manner for cooperating with these surfaces 13′.

The battery elements 2 preferably have a cylindrical outer shape and thus have an outer lateral surface that is entirely exposed to the circulation of natural air internal to the module 1, even when the adjacent elements 2 of a block 2″ or of a row Ri are in contact (maximum occupation density). However, the fixing of a free interval, even a narrow slot (for example at most equal to 1 mm in width), between two adjacent elements 2 can contribute favorably to a circulation of air around said elements 2 and therefore to the thermal control thereof, without compromising the energy storage density of the module 1.

Furthermore, a perforated structure, for the one part, of the crossmembers 8′ of the first wedging means 8 in the form of ladders or of frames with cross pieces and, for the other part, of the plate forming the second wedging means 10, and also a height of the compartmentalizing walls 5 less than that of the blocks 2″ also promotes a circulation of air in a battery 20 containing one or more battery modules 1.

Moreover, in order to simultaneously ensure secure locking in position, in spite of manufacturing tolerances, in particular in the direction of the longitudinal axes AL of the battery elements 2, in an isolated manner or in blocks 2″, and at the same time to ensure the necessary electrical connection between these elements 2, the module 1 may comprise flexible strips 14, made of an elastically compressible material that is a heat conductor and an electrical insulator, resting on the bottom wall 6 in the different elongate housings 7, advantageously at protruding profiled surfaces 6′ formed in the bottom of said housings 7, and against which the battery elements 2 of the row Ri in question come to bear, by way of their corresponding connection terminals 2′ and, if appropriate, under pressure by second wedging means 10. Said flexible strips 14 extend advantageously, in one or more parts, along the entire length of said housings 7 and receive electrically conductive lines or strips 15 (at least in the form of discontinuous portions) at their surfaces that come into contact with said terminals 2′. These conductive strips or lines 15 can be placed on or integrated into the flexible strips 14 (made for example of silicone) and form part of the electrical connection means 15″ of the battery elements 2 of the module 1.

Thus, in addition to the thermal control by air circulation, the elements 2 are then subjected to thermal control by conduction through the strips 14 and 15 (the strips 15 being advantageously metallic, and therefore likewise good heat conductors), between their lower ends and the bottom wall 6 (this second control method is all the more effective, the higher the internal thermal conduction of the elements 2 along their axis AL).

In addition, said strips or lines 15 are advantageously part of a device 15″ for electrically interconnecting the different elements 2 in the form of a set of lower 15 and upper 15′ bars that connect together adjacent elements 2 in order to connect them in parallel, these groups of elements 2 in parallel of one and the same row Ri being themselves connected in series or in parallel/series (see arrangement of the elements 2 in FIGS. 2, 5, 7). This set of connection bars is itself connected to the electrical connection means 15′″ of the battery module 1 (see FIGS. 3, 4 and 5).

More specifically, the electrical connection of the battery elements 2 of a module 1 may, for example, be organized advantageously on three different levels, depending in particular on the desired voltage/current ratio for a design of a given module 1 (total number of elements 2, length and number of housings 7 of the support body 4).

Thus, a first electrical connection level can be realized between the battery elements 2 of the alignment of elements 2 of a block 2″: it can be of the parallel, parallel/series or series type depending on the desired characteristics.

A second electrical connection level can be realized between blocks 2″, which are adjacent or non-adjacent, of a row Ri of elements 2 mounted in an aligned and wedged manner in an elongate housing 7 of the support body 4.

Lastly, the third electrical connection level can consist in linking the different rows Ri together and to a common connector 15′″ for interfacing with and connecting to the outside that belongs to the module 1 in question.

These electrical connections between elements 2 of a block 2″, between blocks 2″ that make up a row R1 and between rows Ri of a module 1 are realized by combination of the lower conductive strips or lines 15 and the upper conductive strips 15′, together forming a structured electrical connection network linking the lower and upper terminals 2′ of all the elements 2 at the connection terminals or connectors 15′″ of the module 1, as can be seen in particular in FIGS. 1, 5, 6, 12, 15B, 16A and 16B.

Preferably, the different means for wedging the battery elements 2 in position in the module 1 likewise have all the features of the corresponding means that are described and shown in the French patent application 1874281 of Dec. 28, 2018 in the name of the applicant.

In accordance with a preferred design variant of the invention, which is both compact and effective and illustrated in particular in FIGS. 2, 3, 4, 5 and 11, the thermal control means 12 that belongs to said module 1 comprises a wall 16, preferably made of a material that is an insulator or at least a slight heat conductor, that is attached to the external face of the bottom wall 6 of the support body 4 and forms, by cooperation therewith, a sealed double bottom 17, means 18, 18′ for feeding heat-transfer liquid 12 into the interior volume of the double bottom 17 and discharging it therefrom being integrated into said attached wall 16 or formed by being joined to the bottom wall 6.

Preferably, the internal volume of the double bottom 17 comprises one or more path(s) for the heat transfer fluid 12′ to circulate between an inlet port 18 and an outlet port 18′, this/these path(s) being formed either only by formations 16′ integrated into the attached wall 16 of the double bottom 17 or by cooperation of mutually complementary formations present on the bottom wall 6 and on the attached wall 16.

The circulation paths may in particular comprise main circulation ducts 18″ formed laterally in the continuation of the ports 18 and 18′, and optionally transverse secondary circulation paths or routes (not shown specifically), fluid likewise being able to circulate through the entire volume of the double bottom 17, which may or may not be transversely compartmentalized.

According to one advantageous feature of the invention, the profiled support body 4 has, along the lateral sides of the bottom wall 6, outwardly protruding lips 19, and the attached wall 16, which forms the double bottom 17 with the bottom wall 6, is secured to said support body 4 at said lips 19, for example by clip-fastening means 17′, by screw means or by similar mechanical assembly means.

The invention also relates, as shown in FIGS. 4, 5, 6, 15, 16 and 17, to a battery for a motorized vehicle, in particular for a hybrid or electric motor vehicle, characterized in that it comprises at least one battery module 1 as described above.

As can be seen from the abovementioned figures, the battery 20 may be adapted to a large number of formats (size, power) depending on the envisioned use (slave battery, main energy source, backup battery, etc.) and on the power and/or energy that is/are required.

According to a first embodiment of the invention, which can be seen in FIGS. 4 to 6, the battery 20 may comprise a single battery module 1, preferably provided with a specific thermal control means 12, and a cover 21, which is advantageously perforated and preferably made of an electrically insulating material, such as plastic or the like, the walls of which form a U shape and are configured to cover the open faces of the elongate housings 7 of the support body 4 of the module 1, so as to form, with the container 3 of the module 1, a continuous outer shell and a closed enclosure in which the battery elements 2 are held in a manner locked mechanically in position.

The cover 21 may in particular be fixed to reinforced lips or protruding end flanges 21′ of the outer lateral walls of the support body 4.

This cover 21 may be made in one piece or be made up of a plurality of parts (for example two or three parts) that are joined together and to the support body 4.

This cover 21, which is fixed by being screwed or clip-fastened for example at lateral flanges of upper lips 21′ of the support body 4, may be involved in locking the second wedging element(s) 10 in position on the blocks 2″, for example by way of deformed or indented zones 21″ that engage by cooperating with projections 10′ at their recessed ends opposite to their conical ends that provide the beveled surfaces that engage with the sites or cutouts 11′.

According to a second embodiment of the invention, which can be seen in FIGS. 15 and 16, the battery 20 may comprise two battery modules 1 that are joined together with their respective bottom walls 6 facing one another in a spaced-apart manner and a volume 22 for heat-transfer fluid 12′ to circulate in being created in between, forming a common thermal control means 12 with inlet and outlet ports 18, 18′, and advantageously two covers 21, the walls of which each form a U shape and are configured to cover the open faces of the elongate housings 7 of one of the two support bodies 1, so as to form, with the two containers 3, two closed, side-by-side enclosures in which the battery elements are held in a manner locked mechanically in position.

Lastly, according to a third embodiment of the invention, illustrated in FIGS. 17 and 18, the battery 20 may comprise at least two, preferably several, battery modules 1 disposed in a first casing part forming a tray 23 and having receiving locations 24 for said modules 1, each of said locations 24 having a thermal control means 12 either in the form of a reinforced wall portion that forms a double bottom with the bottom wall 6 of the support body 4, or in the form of a support surface for the bottom wall 6, which is temperature controlled, of the support body 4 of a battery module 1, a second casing part forming a cover (not shown) being provided to create, by cooperation with the abovementioned first part 23, a closed casing, integrating thermal control means and means for electrical connection of the different modules 1 to one another.

The thermal control means integrated in the tray 23 and, if appropriate, in the cover of the casing may, for example, correspond to the control means described and shown in more detail in the French patent applications 1853129, 1853131 and 1856167 in the name of applicant.

Of course, the invention is not limited to the embodiments described and shown in the appended drawings. Modifications remain possible, in particular as regards the makeup of various elements or by substitution of equivalent techniques, without otherwise departing from the scope of protection of the invention.

1. An electric battery module (1), in particular a motor vehicle battery module, comprising a plurality of individual accumulators (2) in the form of battery elements or cells of elongate, and preferably cylindrical, shape, these battery elements (2), which exhibit higher thermal conductivity in their longitudinal direction than in their radial direction, being arranged in parallel rows (Ri), connected electrically together and to the terminals of the module (1) and mounted in a container (3) that forms part of said module (1), said battery module (1) being characterized in that the container (3) comprises:
for the one part, at least one support body (4) made of a rigid material that is a good heat conductor, in particular a metal material such as aluminum or an alloy thereof, this support body (4) being in the form of a profiled component having a comb-shaped cross section, with a plurality of compartmentalizing walls (5) that are mutually parallel and regularly spaced apart from one another and with a bottom wall (6) connecting said compartmentalizing walls (5) to their bases, each pair of adjacent compartmentalizing walls (5) delimiting, with the bottom wall (6), a profiled groove (7) forming an elongate housing configured to receive, in a non-fitted manner, a row (Ri) of battery elements (2) with their longitudinal axes (AL) perpendicular to the bottom wall (6) and bearing on the latter, and,
for the other part, at least first mechanical wedging means (8), which are attached or integrated and extend at least partially between two adjacent battery elements (2), for all the elements (2) in one and the same row (Ri), so as to limit, preferably prevent, the movements of said elements (2) at least in the longitudinal direction (DL) of the housing (7) that receives them and to space apart said elements (2) from the two compartmentalizing walls (5) that define the elongate housing that receives them.

2. The battery module as claimed in claim 1, characterized in that the first wedging means (8) consist either of attached spacing components that are interposed between the faces of the two opposite compartmentalizing walls (5) of each housing (7) and the battery elements (2) received in this housing (7), or of protruding, profiled or non-profiled, formations that project from the faces of said walls (5), these components or these formations (8) being configured and positioned to form gaps between the battery elements (2) and said faces (5′) of the walls (5), advantageously to keep the battery elements (2) away from the faces (5′) in question in each case, preferably to lock them in position in a centered manner in the housing (7) in question.

3. The battery module as claimed in claim 1 or 2, characterized in that the first wedging means (8) consist, for each housing (7), of attached components in the form of ladders, or of frames provided with cross pieces, the crossmembers or cross pieces (8′) of which constitute or carry stopping and spacing elements that are positioned respectively between two adjacent battery elements (2) and act as linear or surface contact zones (8″″) with the latter, these wedging components (8) being disposed between the faces (5′) of the compartmentalizing walls (5) and the row (Ri) in question of battery elements (2), on either side thereof, each pair of opposite wedging components (8) thus forming a cage confining at least a part of the battery elements (2) of the row (Ri) received in the profiled housing (7) in question.

4. The battery module as claimed in claim 3, characterized in that the side members (8″) of the ladder- or frame-like wedging components (8) have edges (8′″) configured to come into contact, between two crossmembers or cross pieces, with the upper and lower ends of the cylindrical battery elements (2), if appropriate under pressure and/or with elastic deformation, specifically at the lateral edge portions of said ends, the battery elements (2) confined between two wedging components (8) thus forming a block (2″) therewith.

5. The battery module as claimed in claim 1 or 2, characterized in that the first wedging means (8) consist of protruding formations, such as bosses, ridges, spikes or the like, that are an integral part of the faces of the compartmentalizing walls (5) or of components mounted on the latter, for example by interlocking.

6. The battery module as claimed in any one of claims 1 to 5, characterized in that the container (3) comprises second wedging means (10) configured and arranged to lock the battery elements against the bottom wall (6), these second wedging means (10) advantageously being in the form of a panel having a meshwork structure extending above the elongate housings (7) of the support body (4) and the different rows (Ri) of battery elements (2) and, if appropriate, coming into mechanical engagement with the first wedging means (8), above the compartmentalizing walls (5), in order to ensure that they are fixed in position in the upper part of the housings (7) and to ensure that they cooperate intimately with said battery elements (2).

7. The battery module as claimed in claims 4 and 6, characterized in that the meshwork-structure panel (10) has formations (10′) that are conical, beveled or in the form of wedges configured to be inserted between the upper side members (8″) of ladder- or frame-like first wedging components (8) disposed on either side of a given compartmentalizing wall (5), at sites (11) with complementary shapes to said side members (8″), so as to urge each of said side members (8″) and the crossmembers (8′) to come into contact with the battery elements (2) in question in each case that are sandwiched between two mutually opposite first wedging components (8).

8. The battery module as claimed in any one of claims 1 to 7, characterized in that the bottom wall (6) is subjected, preferably substantially over its entire surface, to the action of a thermal control means (12), for example of the type involving circulation of heat transfer fluid (12′), said thermal control means (12) either belonging to said module (1) in question, or being shared between at least two modules (1), or belonging to a set of thermal control means associated with a plurality of modules (1).

9. The battery module as claimed in any one of claims 1 to 8, characterized in that the compartmentalizing walls (5) having, on their two faces (5′), a non-flat surface structure (5″), for example provided with a pattern of grooves/ribs or profiled undulations, the junction zones (13) of said compartmentalizing walls (5) with the bottom wall (6) advantageously having a section that flares in the direction of the latter, providing inclined or beveled laterally supporting and centering surfaces for the first wedging means (8) and/or the battery elements (2).

10. The battery module as claimed in any one of claims 1 to 9, characterized in that it comprises flexible strips (14), made of an elastically compressible material that is a heat conductor and an electrical insulator, resting on the bottom wall (6) in the different elongate housings (7), advantageously at protruding profiled surfaces (6′) formed in the bottom of said housings (7), and against which the battery elements (2) of the row (Ri) in question come to bear, by way of their corresponding connection terminals (2′) and, if appropriate, under pressure by second wedging means (10), said flexible strips (14) extending advantageously, in one or more parts, along the entire length of said housings (7) and receiving electrically conductive lines or strips (15) at their surfaces that come into contact with said terminals (2′), these conductive strips or lines (15) being placed on or integrated into the flexible strips (14) and forming part of the electrical connection means (15″) of the battery elements (2) of the module (1).

11. The battery module as claimed in claim 8 or either one of claims 9 and 10 where these refer back to claim 8, characterized in that the thermal control means (12) that belongs to said module (1) comprises a wall (16), preferably made of a material that is an insulator or at least a slight heat conductor, that is attached to the external face of the bottom wall (6) of the support body (4) and forms, by cooperation therewith, a sealed double bottom (17), means (18, 18′) for feeding heat-transfer liquid (12′) into the interior volume of the double bottom (17) and discharging it therefrom being integrated into said attached wall (16) or formed by being joined to the bottom wall (6).

12. The battery module as claimed in claim 11, characterized in that the internal volume of the double bottom (17) comprises one or more path(s) for the heat transfer fluid (12′) to circulate between an inlet port (18) and an outlet port (18′), this/these path(s) being formed either only by formations (16′) integrated into the attached wall (16) of the double bottom (17) or by cooperation of mutually complementary formations present on the bottom wall (6) and on the attached wall (16).

13. The battery module as claimed in either one of claims 11 and 12, characterized in that the profiled support body (4) has, along the lateral sides of the bottom wall (6), outwardly protruding lips (19), and in that the attached wall (16), which forms the double bottom (17) with the bottom wall (6), is secured to said support body (4) at said lips (19), for example by clip-fastening means (17′), by screw means or by similar mechanical assembly means.

14. A battery (20) for a motorized vehicle, in particular for a hybrid or electric motor vehicle, characterized in that it comprises at least one battery module (1) as claimed in any one of claims 1 to 10.

15. The battery as claimed in claim 14, characterized in that it comprises a single battery module (1), preferably provided with a thermal control means (12) as claimed in one of claims 11 to 13, and a cover (21), which is advantageously perforated and preferably made of an electrically insulating material, such as plastic or the like, the walls of which form a U shape and are configured to cover the open faces of the elongate housings (7) of the support body (4) of the module (1), so as to form, with the container (3), a continuous outer shell and a closed enclosure in which the battery elements (2) are held in a manner locked mechanically in position.

16. The battery as claimed in claim 14, characterized in that it comprises two battery modules (1) that are joined together with their respective bottom walls (6) facing one another in a spaced-apart manner and a volume (22) for heat-transfer fluid (12′) to circulate in being created in between, forming a common thermal control means (12) with inlet and outlet ports (18, 18′), and advantageously two covers (21), the walls of which each form a U shape and are configured to cover the open faces of the elongate housings (7) of one of the two support bodies (1), so as to form, with the two containers (3), two closed, side-by-side enclosures in which the battery elements are held in a manner locked mechanically in position.

17. The battery as claimed in claim 14, characterized in that it comprises at least two, preferably several, battery modules (1) disposed in a first casing part forming a tray (23) and having receiving locations (24) for said modules (1), each of said locations (24) having a thermal control means (12) either in the form of a reinforced wall portion that forms a double bottom with the bottom wall (6) of the support body (4), or in the form of a support surface for the bottom wall (6), which is temperature controlled, of the support body (4) of a battery module (1), a second casing part forming a cover being provided to create, by cooperation with the abovementioned first part (23), a closed casing, integrating thermal control means and means for electrical connection of the different modules (1) to one another.
